(19) United States
(12) Patent Application Publication
(10) Pub. No.: US 2014/0356815 A1
(43) Pub. Date: Dec. 4, 2014

(54) BLANK AND METHOD FOR PRODUCING A DENTAL PROSTHESIS

(71) Applicant: Merz Dental GmbH, Lutjenburg (DE)

(72) Inventors: Jody Paul Spalt, Lutjenburg (DE); Christian Borowski, Lutjenburg (DE); Frank Becker, Lutjenburg (DE)

(21) Appl. No.: 14/354,235

(22) PCT Filed: Oct. 25, 2012
(86) PCT No.: PCT/EP2012/004468

§ 371 Date: Aug. 8, 2014

(30) Foreign Application Priority Data
Oct. 25, 2011 (DE) DE 102011116853.6

(51) Int. Cl. A61C 13/00; G06F 17/50; A61C 13/34

(52) U.S. Cl. CPC A61C 13/0004; A61C 13/34; G06F 17/50
USPC 433/213

(57) ABSTRACT

Embodiments relate to a dental prosthesis molding block for producing a dental prosthesis part, to a corresponding method for producing a dental prosthesis part, and to such a dental prosthesis part. The dental prosthesis molding block has a dentin zone, which is embedded into an enamel region, a boundary surface thus being formed. The boundary surface of the dentin zone has a first dentin surface, which is directed toward the labial surface of a first potential dental prosthesis part, and a second boundary surface for forming a second dentin surface, which is directed toward the labial surface of a second potential dental prosthesis part. The first and second dentin surfaces preferably have respective convex shapes, wherein the sizes and/or shapes of the two dentin surfaces preferably differ from each other.

The present invention relates to a dental prosthesis moulding block for producing a dental prosthesis part, to a method for producing the dental prosthesis part, and to a dental prosthesis part produced from the dental prosthesis moulding block according to the preambles to Claims 1, 13 and 16.

Within the framework of the planning and production of the prosthesis for missing natural teeth or areas of teeth, automated CAD/CAM methods and chip removal methods or copy milling methods are increasingly being used, the respective dental prosthesis part, for example a dental crown, an inlay, an onlay or the like being carved out from a dental prosthesis moulding block.

This makes it possible for manufacturers to offer high, consistent quality and an accurate fit of the dental prosthesis, with at the same time reasonable prices. However, in order to come as close as possible to the model of natural teeth and to meet aesthetic requirements, in particular with regard to colouring, it is often necessary to vary the size or colour of the dental prosthesis part milled from a moulding block.

Disclosed by the prior art, among other things, are multi-coloured plastic moulds with pre-specified varying layers of colour which are arranged around a core, for use in the production of a dental prosthesis, as described for example in U.S. Pat. No. 4,970,032 A.

U.S. Pat. No. 5,151,044 discloses a mould for the production of dental prosthesis parts which can be produced in a desired colour, the mould comprising a core region and three different layers, the layers have a predetermined colour in order to simulate the dentin and enamel zones of a real tooth. By removing the respective layers to different extents, a dental prosthesis part can thus be produced which comes closest to the colouring of the original tooth. The colour of the tooth is predominantly defined here by the colour of the dentin.

The dental enamel modulates the perception of colour by means of different degrees of translucency, transparency and thickness,

WO 2008/083358 also describes a blank for the production of dental prosthesis parts which has a different colour in an outer zone than in an inner zone.

WO 2010/0010082 discloses a mould made of a dimensionally stabilised material that has at least a first component and a second component, the second component having different colouring than the first component, and the second component being disposed within the first component, thus forming an interface such that the interface constitutes a spatially curved surface. The mould is formed here such that the interface corresponds at least partially to the profile of the dentin/enamel boundary of natural or artificial teeth. In particular, the colourings of the first component and the second component are chosen such that they come as close as possible to the enamel or dentin colouring of a natural tooth or an artificial tooth. It is also a disadvantage here that a material-saving arrangement, in particular for the restoration of anterior teeth, is not provided.

A disadvantage of the moulds and methods of the prior art arises, among other things, from the fact that in order to produce an accurately fitting dental crown with a given stump, the latter must be covered with sufficient dentin material in order to achieve a natural colour effect. It is therefore desirable to provide the dentin core of a moulding in different sizes in order to also cope with a given dental situation as regards colour aesthetics. At the same time, however, the number of required moulding blocks should be kept as low as possible depending on the situation regarding the stump of the tooth for reasons relating to cost and material.

Accordingly, it is the object of the present invention to provide a dental prosthesis moulding block with an inner dentin-like core which allows simple, inexpensive size and/or colour variation of the dental prosthesis part to be produced.

Furthermore, it is an object of the present invention to provide a method of producing a dental prosthesis part with which the size and/or the colour effect of the dental prosthesis part to be produced can be chosen, as well as a tooth prosthesis part to be produced by this method. This type of variation of the moulding block would lead to a considerable reduction of required moulding blocks and so to a considerable saving of material and costs.

This object is achieved according to the invention in that for the production of a dental prosthesis part the dental prosthesis moulding block has a dentin zone or a dentin-like zone which is embedded into a enamel region, an boundary surface thus being formed, the boundary surface of the dentin zone having at least a first boundary surface for the formation of a first dentin surface which is directed toward the labial surface of a first potential dental prosthesis part, and a second boundary surface for the formation of a second dentin surface which is directed toward a second potential dental prosthesis part.

By means of this type of configuration of the dentin zone and of its boundary surfaces within the mould the size and/or the colour appearance of the dental prosthesis part to be produced can now be determined in advance by choosing at least a first or a second boundary surface with is directed toward the labial surface, i.e. the surface on the lip side, of a first or second potential dental prosthesis part. This is suitable in particular for dental prosthesis parts of the anterior and/or canine tooth region.

Preferably, the first and second dentin surfaces form opposing surfaces of the dentin zone here. Thus, for example, a dental prosthesis part of a different size or a different colour can be produced selectively, for example, from two different, opposing directions of the dental prosthesis moulding block, the resulting labial surfaces preferably being assignable to an incisor and/or a canine. The profile of the first and the second dentin surface has over the entire surface a slightly convex curvature and tapers toward the neck of the tooth or toward the tip of the tooth. The surface on the palate side, i.e. the palatinal surface of the dental prosthesis part that can be produced in this way is hollowed out more or less deeply and optionally cuts the dentin zone at least partially, however this part is not visible to the outside. In the approximal direction the first and the second dentin surface of the mould form a common cutting region, preferably a common cutting line. Also conceivable is a bicuspid structure of the dentin core, the two cusps having a same or preferably a different height and/or width.

The dental prosthesis moulding block is preferably produced from dental materials based on ceramic materials and/or acrylates coloured similarly to teeth, the dentin zone and the enamel region preferably being produced from the same material. The dentin zone and the enamel region of the dental prosthesis moulding block preferably have different pigmentations here, the enamel region modulating the perception of colour by differently pronounced transparency and in particular thickness. The colour effect is produced, however, predominantly by the colour of the dentin. According to experience the required artificial enamel layer thickness often differs considerably from the anatomical enamel layer thickness. The mould of the present invention advantageously permits a high degree of flexibility here with at the same time low material consumption.

Preferably, the dentin zone of the dental prosthesis moulding block is entirely surrounded by the enamel region.

The cutting surface of the dentin zone, which cuts both the first dentin surface and the second dentin surface centrally and perpendicularly to the bottom surface of the dental prosthesis moulding block, forms in a first embodiment a shape according to Formula (I):

F(x)=ax⁴+bx³+cx²+dx+e; where (I)

a comes in the range between 0 and 0.05;

b comes in the range between 0 and −0.2;

c comes in the range between 0 and 0.8;

d comes in the range between 0 and −0.15;

e is equal to 0, and the outer line preferably runs asymmetrically with respect to the F(x) axis.

The cutting surface of the dentin zone, which cuts both the first dentin surface and the second dentin surface centrally and perpendicularly to the bottom surface of the dental prosthesis moulding block, forms in a second embodiment a shape according to Formula (II):

F(x)=ax⁴+bx³+cx²+dx+e, where here (II)

a comes in the range between 0 and −0.05;

b comes in the range between 0 and −0.2;

c comes in the range between 0 and 0.4;

d comes in the range between 0 and 0.15; e comes in the range between 0 and 12 mm, preferably between 0 and 11.34, and the outer line preferably runs asymmetrically with respect to the F(x) axis.

The cutting surface of the dentin zone, which cuts both the first dentin surface and the second dentin surface centrally and perpendicularly to the bottom surface of the dental prosthesis moulding block, forms in a particularly preferred third embodiment the shape according to Formula (III):

F(x)=ax⁵+bx⁴+cx³+dx²+ex+f; where here (III)

a comes in the range of smaller than equal to 0 and −0.05;

b comes in the range of smaller than equal to 0 and −0.2;

c comes in the range between 0 and 0.2;

d comes in the range between 0 and −0.8;

e comes in the range between 0 and 0.5;

f comes in the range between 0 and 10, preferably between 8 and 9.8, and preferably the outer line runs asymmetrically with respect to the F(x) axis.

Furthermore, the cutting surface of the dentin zone, which cuts both the first dentin surface and the second dentin surface centrally and parallel to the bottom surface of the dental prosthesis moulding block, preferably forms a shape according to Formula (IV):

G(x)=fx⁴+gx²+h; where (IV)

f comes in the range between −0.001 and 1;

g comes in the range between −0.2 and 0.2;

h comes in the range between −0.06 and 6; and

the outer line preferably runs symmetrically with respect to the G(x) axis.

Particularly preferably, the cut surface of the dentin zone, which cuts both the first dentin surface and the second dentin surface centrally and parallel to the bottom surface of the dental prosthesis moulding block, forms the shape according to Formula (V):

G(x)=fx⁴+gx³+hx²+ix+j; where (V)

f comes in the range between −0.001 and 0.05;

g comes in the range between −0.002 and 0.005;

h comes in the range between −0.2 and 0.2;

i comes in the range between −0.06 and 0.06;

j comes in the range between −4.5 and 5.5; and preferably the outer line runs symmetrically with respect to the G(x) axis.

The dentin zone of the dental prosthesis moulding block is preferably placed on a dentin base surface, the dentin base surface forming the entire base surface of the dental prosthesis moulding block.

By forming the first and the second dentin surface in a respectively convex shape, but in different sizes and with different, non-mirror symmetrical contour extensions, a plurality of possible prosthetic situations are advantageously provided within one moulding block, and this means a clear saving of material for production of the dental prosthesis part. In particular, the respective first and second dentin surfaces have different surface areas and/or different surface shapes which enable selective preparation of desired dental prosthesis parts. Production requires that the lower region of the dentin zone, which sits on a dentin base surface of the dental prosthesis moulding block, preferably undergoes transition into the latter without any change to its convex shape or curvature. Therefore, no turning point is provided in the lower region of the respective parabola contour of the two dentin surfaces. Moreover, an artificial tooth to be produced, preferably an anterior tooth or canine, can respectively be assigned to a region of the first or the second dentin surface in the moulding block or be virtually placed in the latter, depending on the desired size or colouring.

According to the invention a method for producing a dental prosthesis part comprises the following steps:
a) providing a dental prosthesis moulding block;
b) selecting at least one dentin surface;
c) producing a dental prosthesis part that can be disposed in the anterior tooth and/or canine region in optionally at least two different sizes and/or colours using a CAD/CAM method by means of removing material from the dental prosthesis moulding block.

Preferably, material is removed here such that the colour of the resulting dental prosthesis part can be determined by the selectable dentin surface and/or the layer thickness of the enamel region.

The colour of the resulting dental prosthesis part can preferably be determined in advance using the layer thickness of the remaining enamel region by means of CAD software.

The dental prosthesis part according to the invention, which is produced in a selectable size and/or colour from a dental prosthesis moulding block by the method described above, preferably has the shape of an anterior tooth or canine.

Further details and features of the dental prosthesis moulding block according to the invention are given by the following description of exemplary embodiments using the drawings. The drawings show as follows:

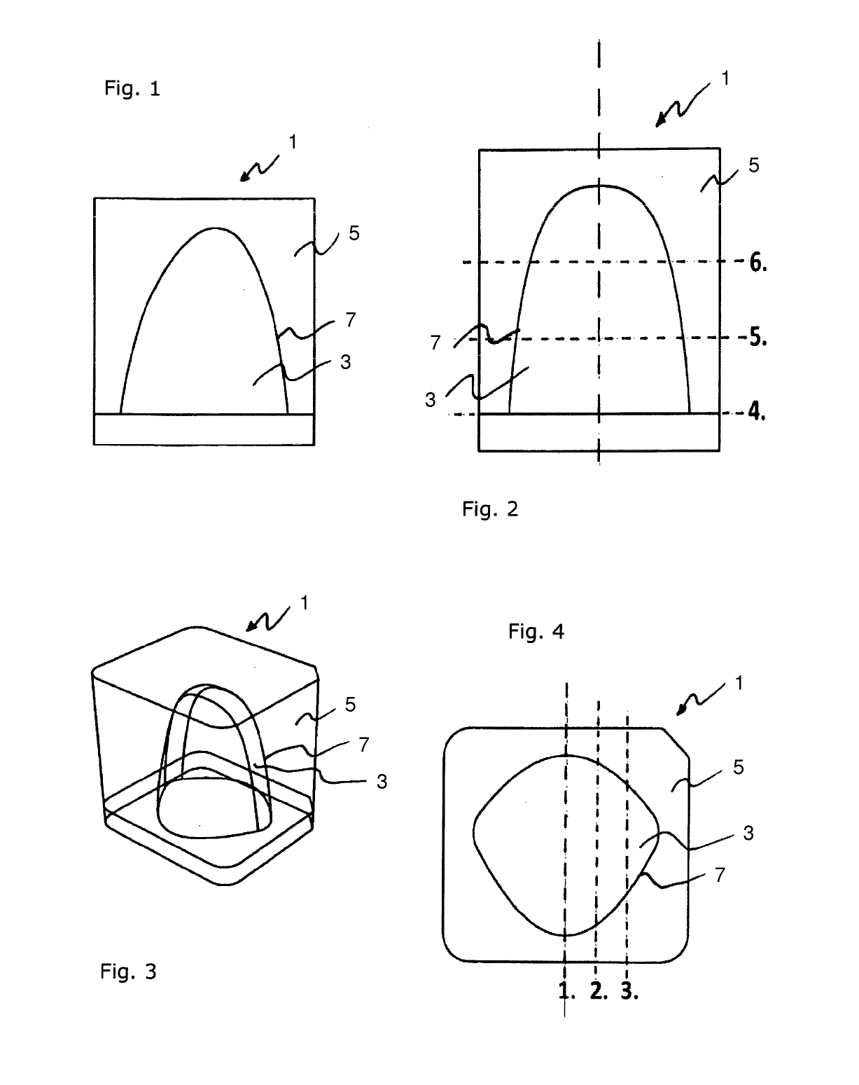

FIG. 1 an approximal view of a dental prosthesis moulding block according to the invention;

FIG. 2 a vestibular view of a dental prosthesis moulding block according to the invention;

FIG. 3 an oblique view of a dental prosthesis moulding block;

FIG. 4 an incisal top view of a dental prosthesis moulding block;

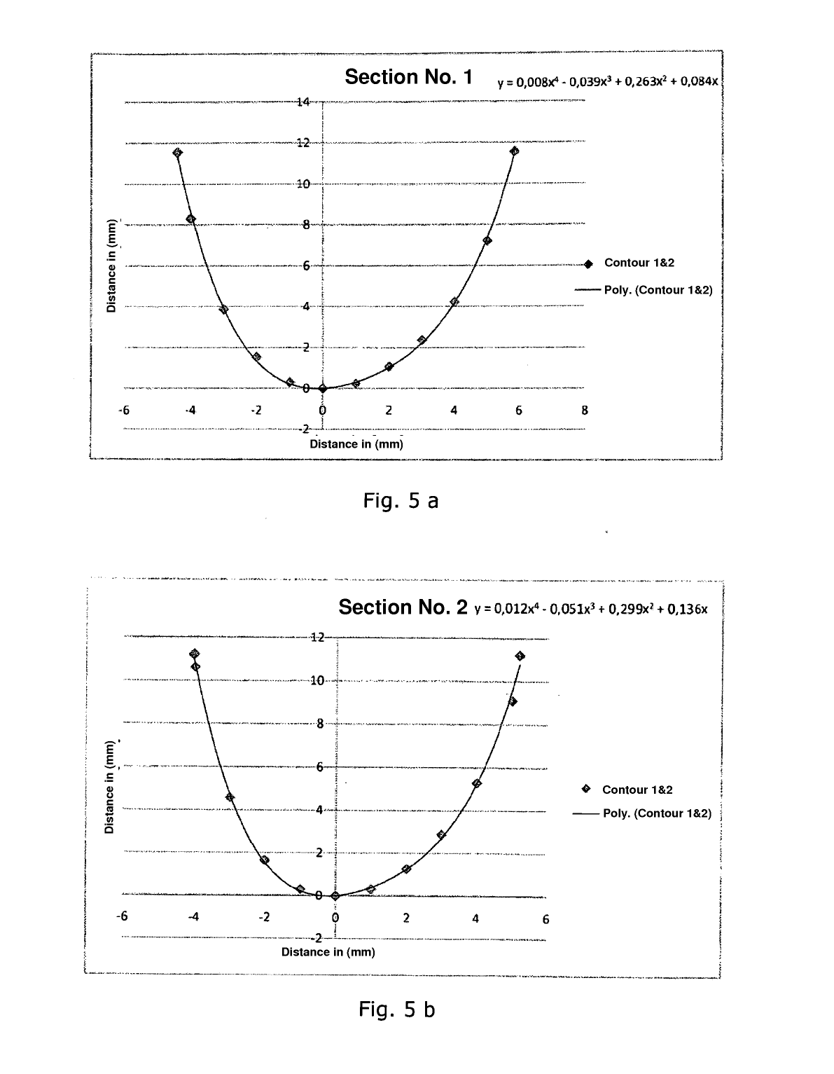

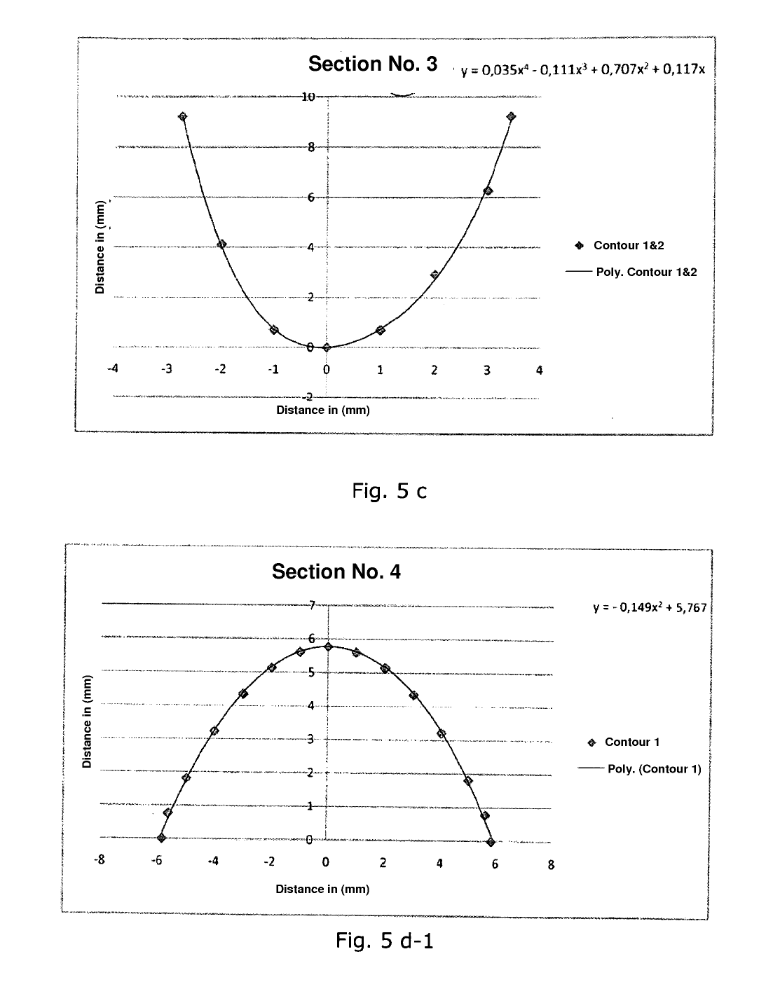

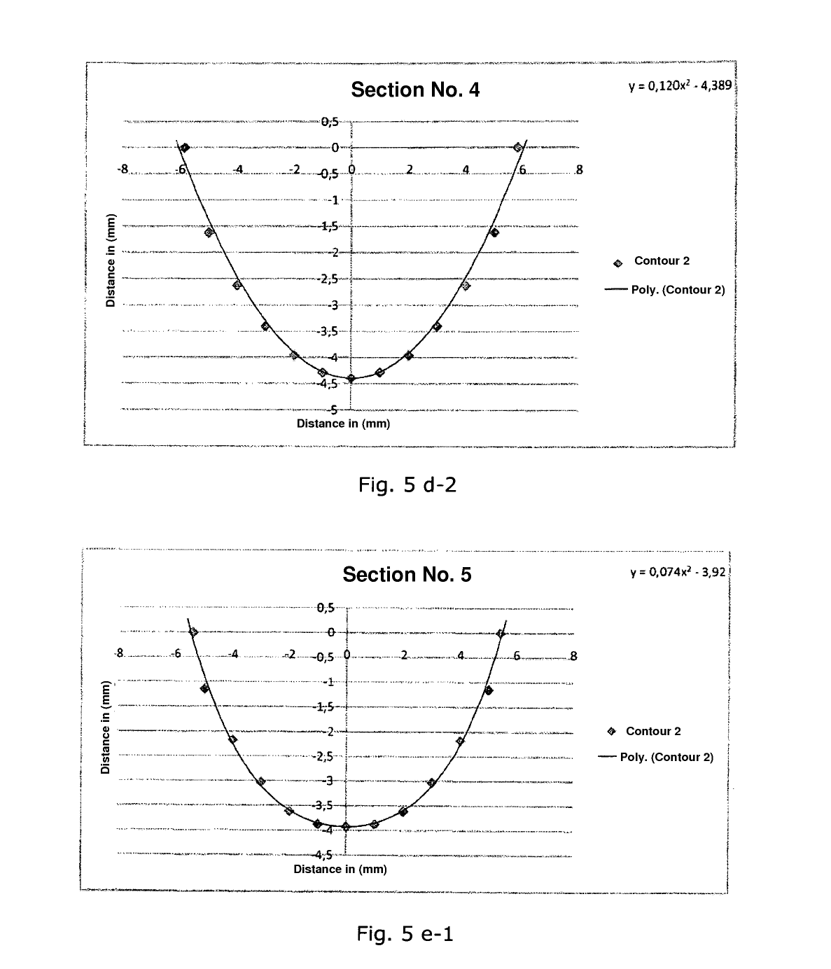

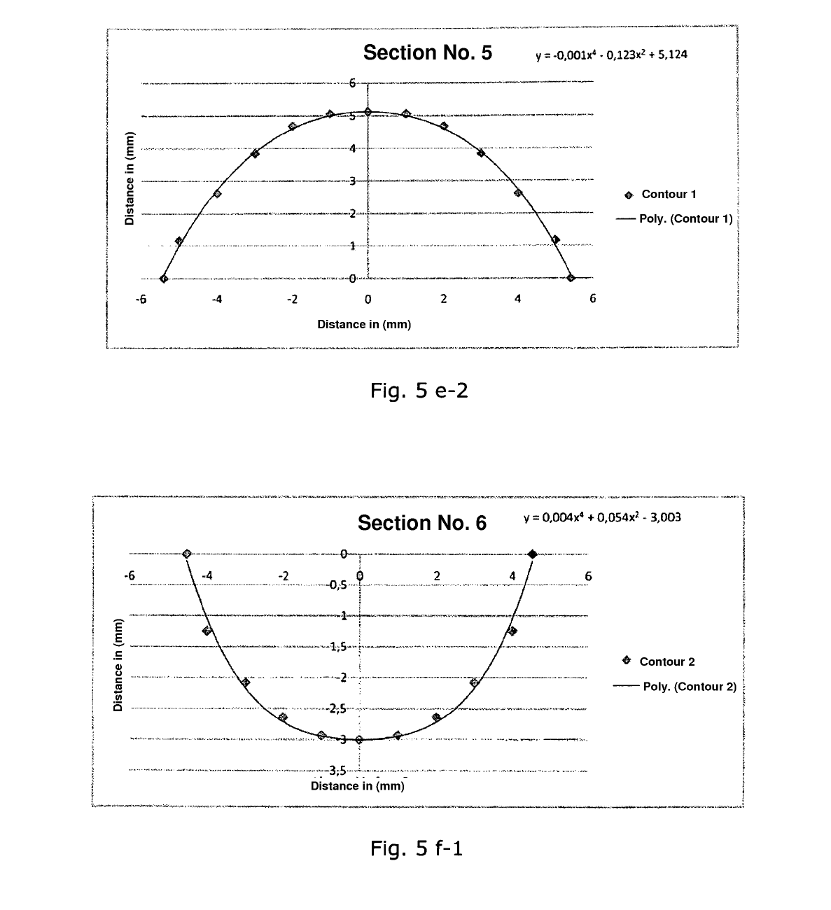

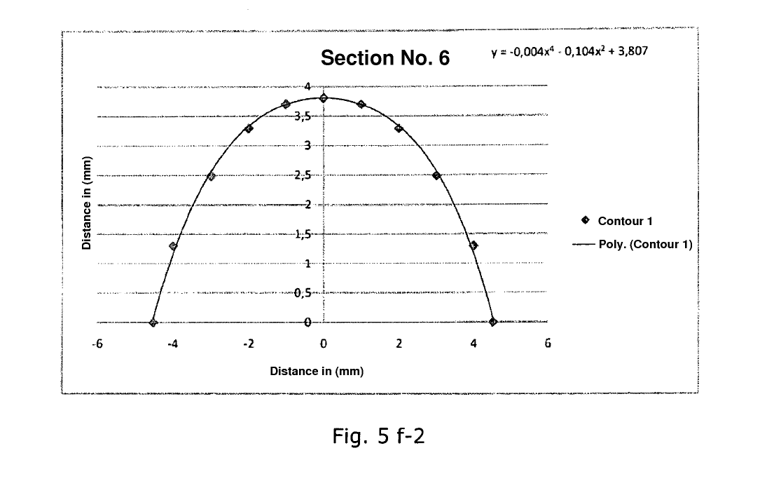

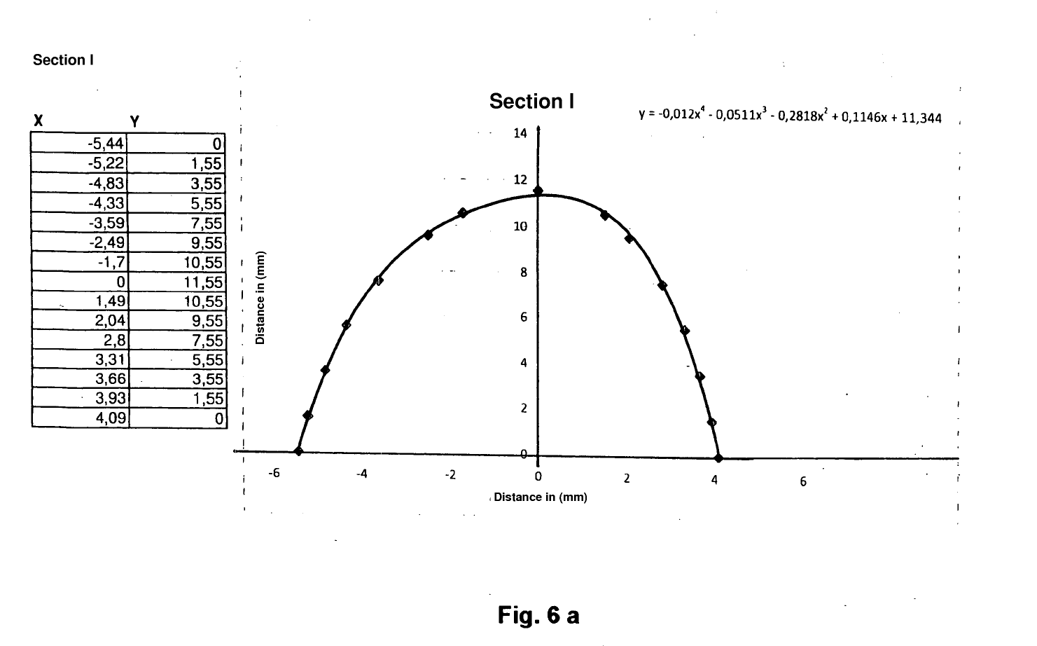

FIG. 5a-f a graphical illustration of the function of three respective cuts 1,2,3 in the vertical and mesiodistal (a, b, c) and horizontal 4,5,6 (d-1,2; e-1,2; f-1,2) direction of the dentin core;

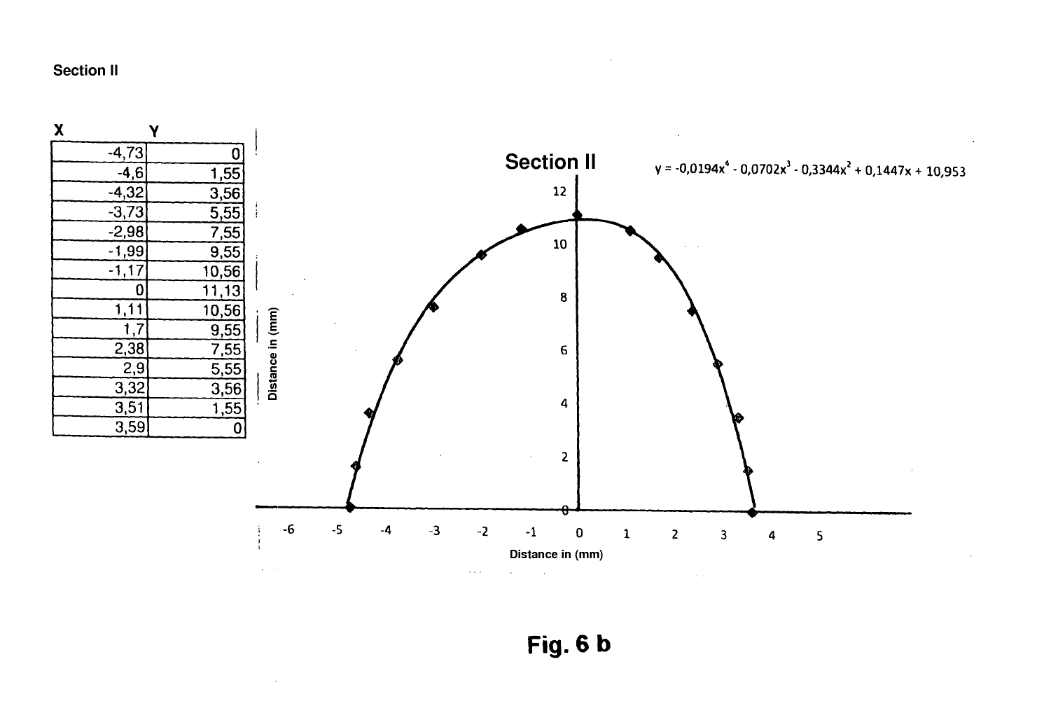

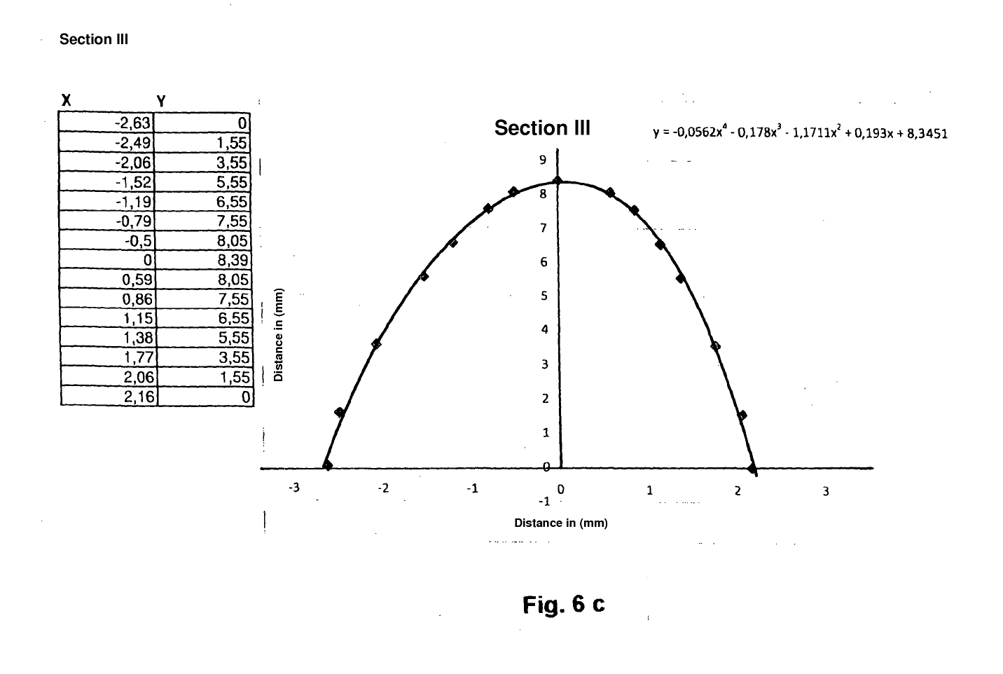

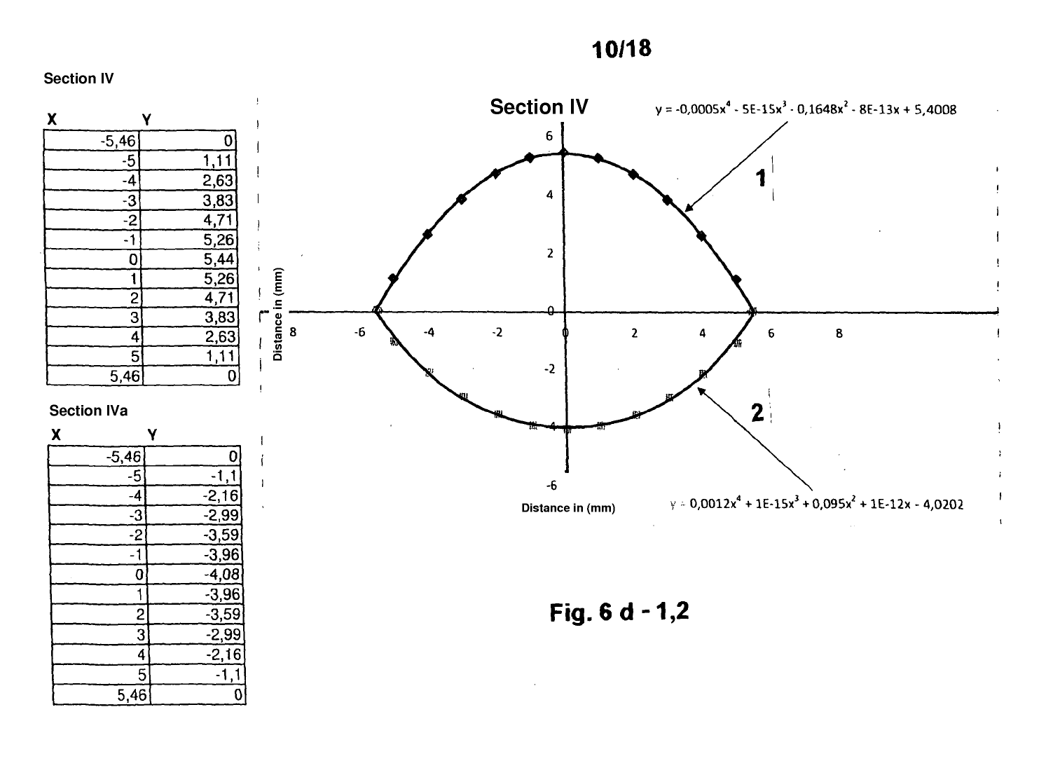

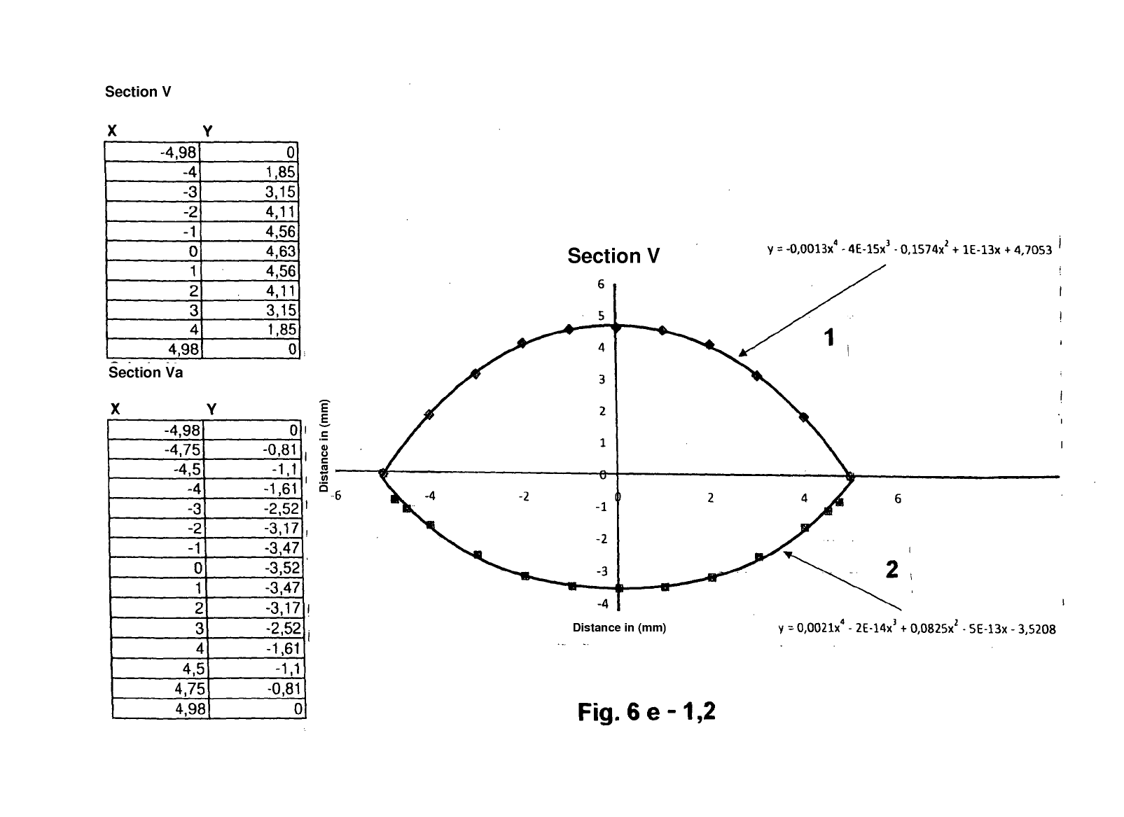

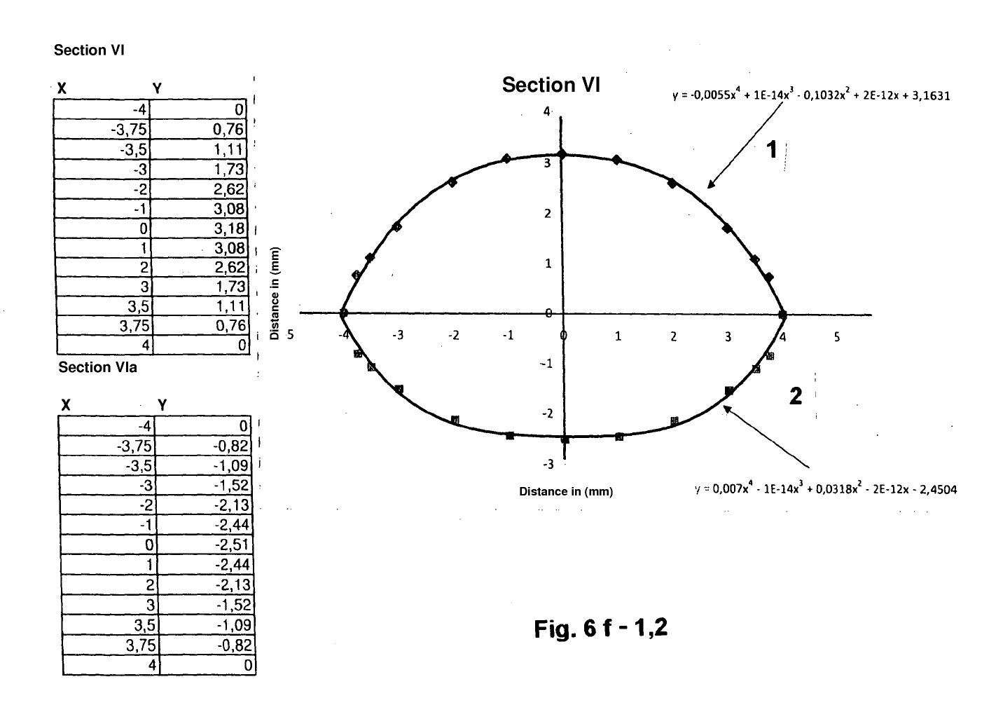

FIG. 6a-f a graphical illustration of the function of three respective cuts I,II,II in the vertical and mesiodistal (a, b, c) and cuts IV, V, VI in the horizontal (d-1,2; e-1,2; f-1,2) direction of the dentin core; and

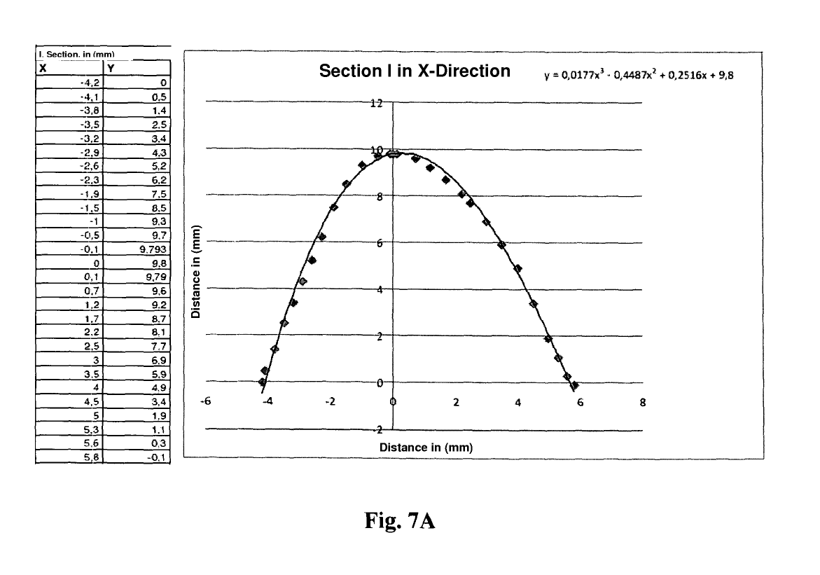

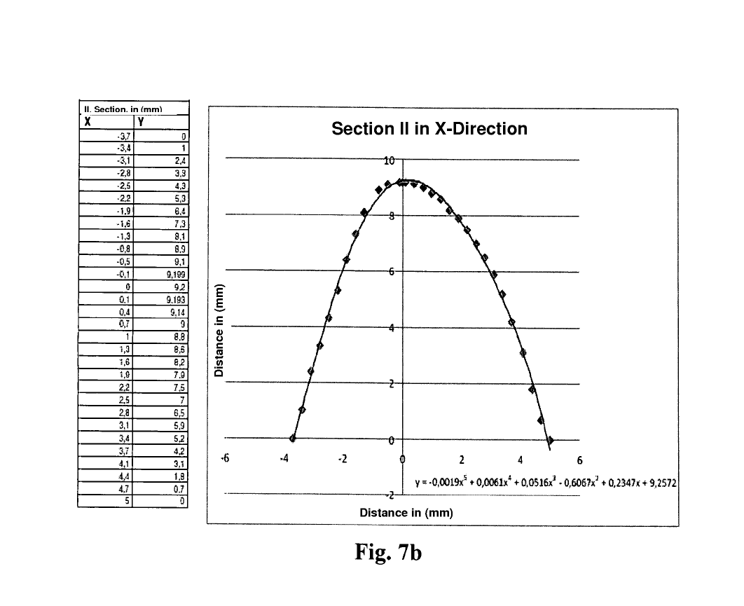

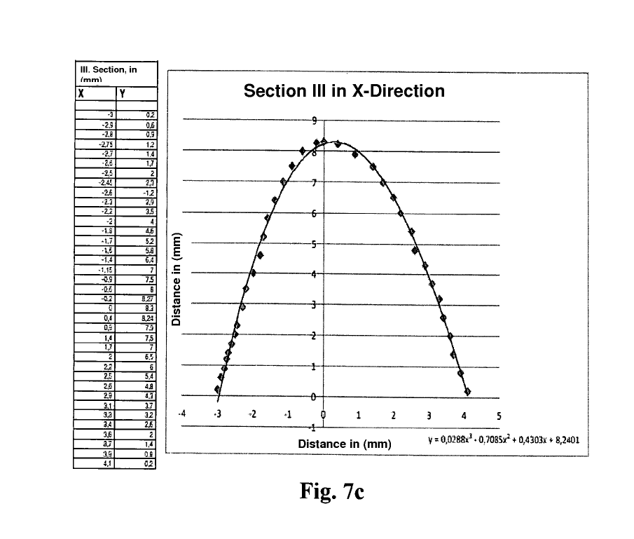

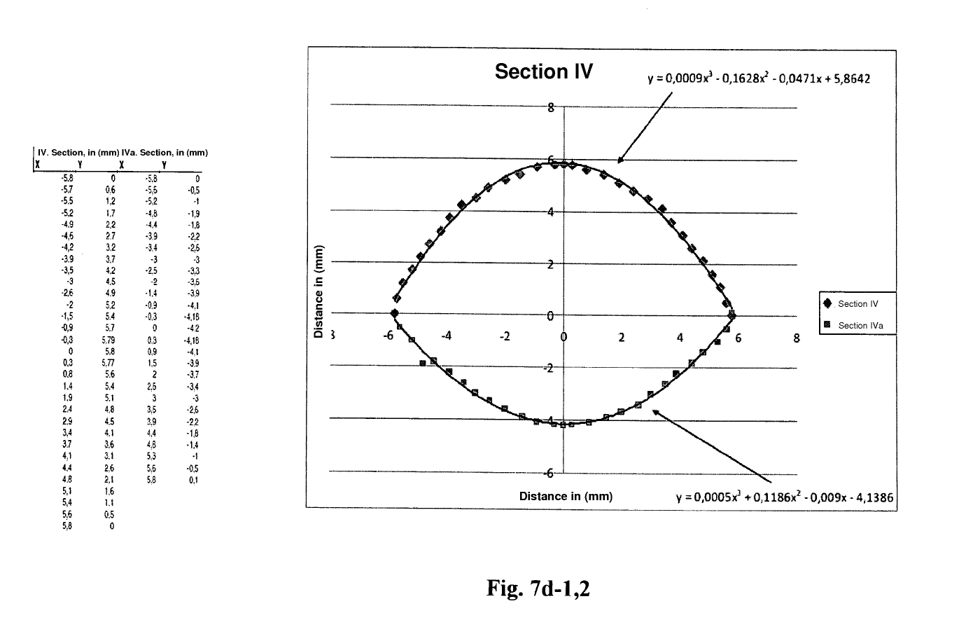

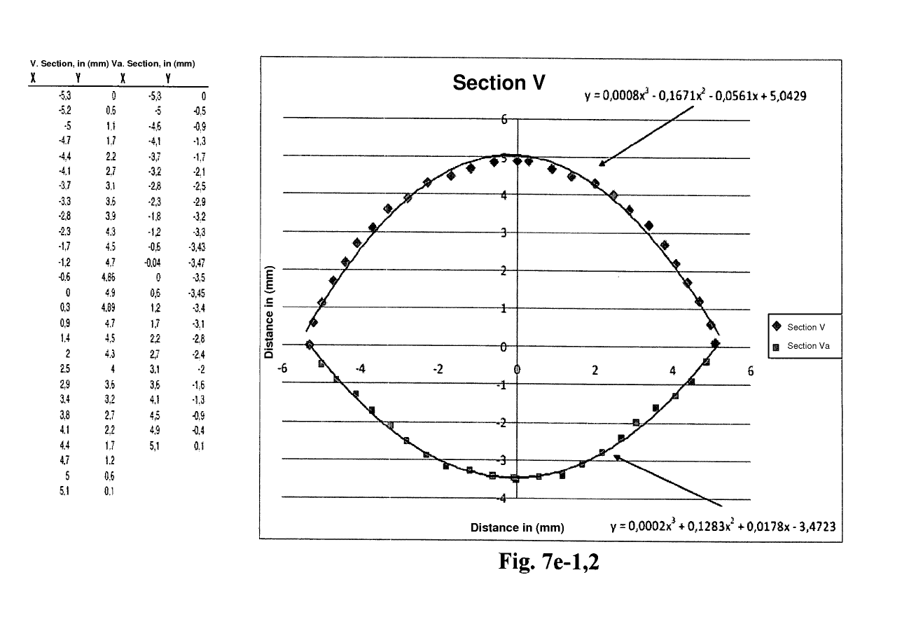

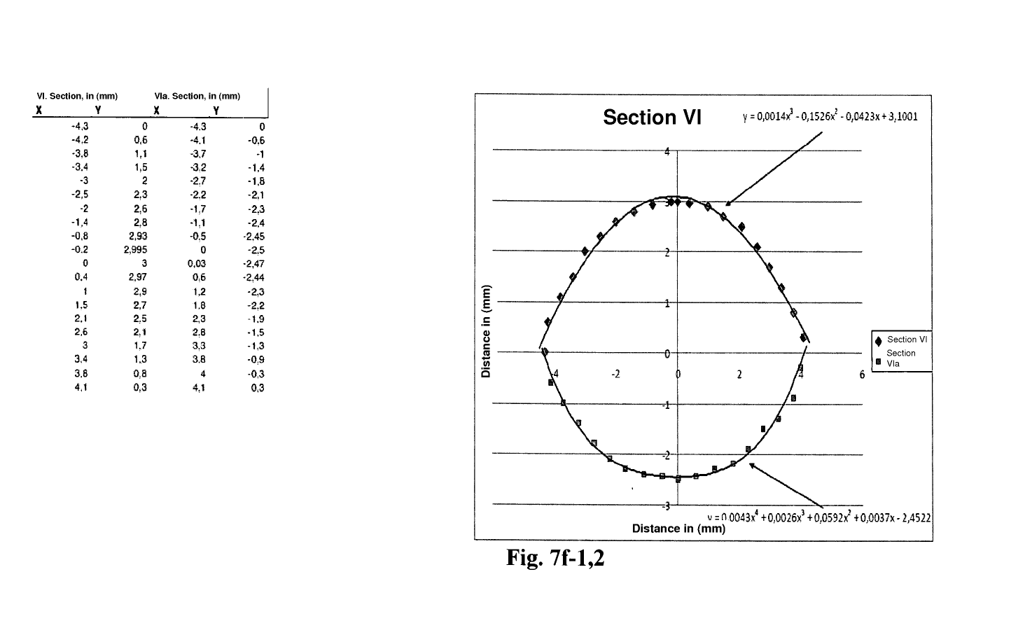

FIG. 7a-f a graphical illustration of the function of three respective further cuts I,II,III in the vertical and mesiodistal (a, b, c) and cuts (IV, V, VI) in the horizontal (d-1,2; e-1,2; f-1,2) direction of the dentin core.

The moulding block 1 shown in FIGS. 1 and 2 is used to produce dental prosthesis parts, such as for example a dental crown, preferably in the region of the anterior teeth and/or canines. The moulding block 1 has a dentin zone 3 which is embedded into a enamel region 5, an boundary surface 7 thus being formed. The boundary surface 7 of the dentin zone 3 has a first dentin surface which is directed toward the labial surface of a first potential dental prosthesis part. A second boundary surface lying opposite the first boundary surface for forming a second dentin surface which is directed toward the labial surface of a second potential dental prosthesis part lies opposite the first boundary surface. The first and the second dentin surface respectively have a convex shape, the size and/or shape of the two dentin surfaces preferably differing from each other. By thus varying the dentin zone 3 in two opposing directions of the moulding block 1 it is advantageously made possible to cover the same number of prosthetic situations or alternatives with a reduced number of dental prosthesis moulding blocks. In a first embodiment, the width of the bottom section of the dentin cutting surface shown in FIG. 1 is for example approximately 9.53 mm, and in a second embodiment 10.24 mm. The width of the bottom section of the dentin cutting surface shown in FIG. 2 is for example approximately 10.91 mm and in a second embodiment 11.68 mm, the width of the bottom section of the entire moulding block 1 in both embodiments being approximately 13.40 mm; the height of the dentin cutting surface is approximately 13.46 mm here, and the height of the entire dental prosthesis moulding block 1 is approximately 15.30 mm. These are only guide values relating to standardised dental moulding blocks which can optionally take on different values depending on the situation.

The labial dentin or tooth surface, i.e. the surface placed towards the lip, can be seen by means of the cross-sectional illustration of FIG. 2. The anterior tooth region is labially identical to the vestibular direction. Not visible in this illustration is a second dentin surface which is directed toward the labial surface of a second dental prosthesis part, this second boundary surface for the formation of the second dentin surface preferably having a size and/or shape differing from the first boundary surface. The first and the second dentin surface correspond here to opposing surfaces of the dentin zone 3 of the dental prosthesis moulding block 1. Thus, a prosthesis part which comes closest to the shape and colour of the prosthesis part to be produced can optionally be produced from a mould 1. Therefore, according to the real tooth situation, it can be decided immediately before the start of production which labial shape of the moulding block 1 must be selected in order to remove, mill or grind an appropriate dental prosthesis part from the latter. The first and the second dentin surface accordingly constitute opposing, convexly curved boundary surface 7 which have a common cutting region, preferably a common cutting line, in the approximal direction, i.e. toward the adjacent tooth. The morphology of the dentin zone 3 can however also resemble a double core the two part-regions of which have a respective cusp-like shape and/or height that differ from one another. The dental prosthesis moulding block 1 can consequently be used in a material-saving manner to remove, mill or grind a canine or an anterior tooth with a selectively different size and colour.

The top view of the mould 1 shown in FIG. 4 shows the base surface of the dentin zone 3 within the enamel region 5. If the mould 1 is milled off to such an extent that parts of the outer enamel region 5 are removed and parts of the dentin region 3 are exposed, this region is to be oriented in a palatinal or oral direction which is not visible to the outside after inserting the prosthesis part in the patient. In particular, it can be gathered from the outline that the structure of the dentin core 3 has two surfaces curved to different extents in relation to the bottom surface. The different convex curvature of the two opposing dentin surfaces thus makes it possible to selectively produce two differently shaped or coloured anterior teeth or canines, the different colour impression of the first or the second dental prosthesis part arising in particular from a combination of the selectable dentin surface and the mechanically pre-determinable layer thickness of the enamel region 5 surrounding the dentin zone 3.

The graphical illustrations reproduced in FIG. 5 result from hypothetical cuts through the illustrations of the dentin zone 3 of the moulding block 1 shown in FIG. 2 and FIG. 4. These cuts are designated by numbers 1, 2, 3 in FIG. 4 and numbers 4, 5, 6 in FIG. 2. The cuts 1,2, i.e. a distance of e.g. 2 mm away from cut 1, 3, i.e. a distance of e.g. 4 mm away from cut 1, respectively describe a cutting surface which cuts both the first and the second dentin surface centrally and perpendicularly to the bottom surface of the moulding block 1. The shape of the cutting surface, which cuts both dentin zones centrally and perpendicularly to the bottom surface, corresponds to cutting Formula (I) with e=0. The shape of the two respective opposing cutting surfaces of the cuts 4, i.e. a distance of e.g. 1.90 m away from the base surface, 5, i.e. a distance of e.g. 6.29 mm away from the base surface, 6, i.e. a distance of e.g. 1.90 mm away from the base surface which cuts both dentin zones centrally and parallel to the bottom surface, corresponds to Formula (II).

FIG. 5a-c thus shows a graphical illustration of the function (I) with e=0 of respectively three cuts 1, 2, 3 in the vertical and mesiodistal and FIG. 5d-f three cuts 4, 5, 6 in the horizontal direction of the dentin core 3 in respectively two opposing contours, illustrated in FIGS. 5d-1 and -2, FIGS. 5e-1 and -2, FIGS. 5 f-1 and -2. The graphical illustrations of FIGS. 5a-c and d-f additionally include the functions underlying the shown trend lines, a function respectively underlying the mesiodistal cuts 1, 2, 3. The horizontal cuts 4, 5, 6 in FIGS. 5d-1,2; e-1,2 and f-1,2 describe respectively opposing contours which are described by the respectively specified function and are designated by contour 1 and contour 2.

The function y=0.008 x⁴−0.039 x³+0.263 x²+0.084 x+0 underlies FIG. 5a here,

the function y=0.012 x⁴−0.051 x³+0.299 x²+0.136 x+0 underlies FIG. 5b,

the function y=0.035 x⁴−0.111 x³+0.707 x²+0.117 x+0 underlies FIG. 5c,

the function y=−0.149 x²+5.767+0 underlies FIG. 5d-1,

the function y=0.120 x²−4.389 underlies FIG. 5d-2,

the function y=0.074 x²−3.92 underlies FIG. 5e-1,

the function y=0.001 x⁴−0.123 x²+5.124 underlies FIG. 5e-2,

the function y=0.004 x⁴+0.054 x²−3.003 underlies FIG. 5f-1,

and the function y=−0.004 x⁴−0.104 x²+3.807 underlies FIG. 5f-2.

FIG. 6a-f shows the graphical illustration of the function (II) with e in the range of 0 to 12, preferably between 0 and 11.34 (mm) of respectively three cuts I, II, III in the vertical and mesiodistal and FIG. 6d-f shows three cuts IV, V, VI in the horizontal direction of the dentin core 3 in respectively two opposing contours, designated as d-1,2, e-1,2 and f-1,2. The graphical illustrations of FIGS. 6a-c and d-f additionally include the functions underlying the trend lines shown, a function respectively underlying the mesiodistal cuts I, II, III. In the horizontal cuts IV, V, VI in FIG. 6d-f opposing contours are described by the respectively specified function, i.e. as 6d-1, 2, 6e-1, 2 and 6f-1, 2. The graphical illustration in FIG. 6 corresponds to mirroring in the Y direction of the functions shown in FIG. 5 with changed numerical values.

The function y=−0.012 x⁴−0.0511 x³−0.2818 x²+01146. x+11.344 underlies FIG. 6a here,

the function y=−0.0194 x⁴−0.0702 x³−0.3344 x²+0.1447 x+10.953 underlies FIG. 6b,

the function y=−0.0562 x⁴−0.178 x³−1.1711 x²+0.193 x+8.3451 underlies FIG. 6c,

the function y=−0.0005 x⁴−5E−15 x³−0.1648 x²−8E−13x+5.4008 underlies FIG. 6d-1,

the function y=0.0012 x⁴+1E−15 x³+0.095 x²+1E−12x−4.0202 underlies FIG. 6d-2,

the function y=−0.0013 x⁴−4E−15 x³−0.1574 x²+1E−13x+4.7053 underlies FIG. 6e-1,

the function y=0.0021 x⁴−2E−14 x³+0.0825 x²−5E−13x+−3.5208 underlies FIG. 6e-2,

the function y=−0.0055 x⁴+1E−14 x³+0.1032 x²+2E−12x+3.1631 underlies FIG. 6f-1, and

the function y=0.007 x⁴−1E−14 x³−2E−12x−2.4504 underlies FIG. 6f-2.

FIG. 7a-f shows the graphical illustration of the particularly preferred cutting Formula (III) with f in the range of 0 to 12, preferably between 0 and 9.8 (mm) of respectively three cuts I, II, III in the vertical and mesiodistal and FIG. 7d-f shows three cuts IV, V, VI in the horizontal direction of the dentin core 3 in respectively two opposing contours, designated as d-1,2, e-1,2 and f-1,2. The graphical illustrations of FIGS. 7a-c and d-f additionally include the functions underlying the trend lines shown, a function respectively underlying the mesiodistal cuts I, II, III. In the horizontal cuts IV, V, VI in FIG. 7d-f opposing contours are described by the respectively specified function, i.e. as 7d-1, 2, 7e-1, 2 and 7f-1, 2. The graphical illustration in FIG. 7 corresponds to mirroring in the Y direction of the functions shown in FIGS. 5 and 6 with changed numerical values.

The function y=−0.0177 x³−0.4487 x²−0.2516 x+9.8 underlies FIG. 7a here,

the function y=−0.0019 x⁵+0.061 x⁴+0.0516 x³−0.6067 x²+0.2347 x+9.2572 underlies FIG. 7b,

the function y=−0.0288 x³−0.7085 x²+0.4303 x+8.2401 underlies FIG. 7c,

the function y=−0.0009 x³−0.1628 x²−0.0471x+5.4862 underlies FIG. 7d-1,

the function y=0.0005 x³+0.1186 x²+0.009 x−4.3186 underlies FIG. 7d-2,

the function y=−0.0008 x³−0.1671 x²−0.0561 x+5.0429 underlies FIG. 7e-1,

the function y=0.0002 x³+0.1283 x²+0.0178 x−3.4723 underlies FIG. 7e-2,

the function y=−0.0014 x³−0.1526 x²−0.0423 x+3.1001 underlies FIG. 7f-1. and

the function y=0.0043 x⁴−0.0026 x³+0.0592 x²+0.0037 x−2.4522 underlies FIG. 7f-2.

In a further embodiment the dental prosthesis moulding block is configured such that the dentin zone 3 is placed over a dentin base surface, and this forms the entire base surface of the dental prosthesis moulding block 1.

The method of producing a dental prosthesis part with the previously described dental prosthesis moulding block 1 includes as an essential step the selection of at least one of the two dentin surfaces depending on the requirement of the real tooth situation. In this way a dental prosthesis part can advantageously be produced in optionally at least two different sizes and/or colours from a dental prosthesis moulding block 1. The production is implemented by milling out from a selected side of the dental prosthesis moulding block 1 using CAD/CAM methods. The colour impression of the resulting dental prosthesis part is then determined by the morphology of the selectable dentin surface and the layer thickness of the remaining enamel region 5. As a result, at least a part-region of the palatinal surface of the dental prosthesis part, i.e. the palate-side tooth surface, corresponds to a section of the dentin zone. However, this section is not visible to the outside.

1-17. (canceled)

18. A dental prosthesis moulding block for producing an individual dental prosthesis part of the anterior tooth and/or canine region which has a dentin zone which is embedded into a enamel region, an boundary surface thus being formed, characterised in that the boundary surface of the dentin zone has at least a first boundary surface for the formation of a first dentin surface which is directed toward the labial surface of a first potential dental prosthesis part, and a second boundary surface for the formation of a second dentin surface which is directed toward the labial surface of a second potential dental prosthesis part, the first and the second dentin surface being curved surfaces and having a common cutting region in the approximal direction and the first and the second dentin surface forming opposing labial surfaces of the dentin zone in a respectively convex shape with a different, non-mirror symmetrical contour profile.

19. The dental prosthesis moulding block according to claim 18, the dental prosthesis moulding block being produced from dental materials based on ceramic materials and/or acrylates coloured similarly to teeth, the dentin zone and the enamel region preferably being produced from the same material.

20. The dental prosthesis moulding block according to claim 18, characterised in that the dentin zone and the enamel region have different pigmentations.

21. The dental prosthesis moulding block according to claim 18, characterised in that the dentin zone is entirely surrounded by the enamel region.

22. The dental prosthesis moulding block according to claim 18, characterised in that the cutting surface of the dentin zone, which cuts both the first dentin surface and the second dentin surface centrally and perpendicularly to the bottom surface of the dental prosthesis moulding block, forms the shape according to Formula (I):
F(x)=ax⁴+bx³+cx²dx+e; where (I)
a comes in the range between 0 and 0.05;
b comes in the range between 0 and −0.2;
c comes in the range between 0 and 0.8;
d comes in the range between 0 and 0.15;
e is equal to 0, and
the outer line preferably runs asymmetrically with respect to the F(x) axis.

23. The dental prosthesis moulding block according to claim 18, characterised in that the cutting surface of the dentin zone, which cuts both the first dentin surface and the second dentin surface centrally and perpendicularly to the bottom surface of the dental prosthesis moulding block, forms the shape according to Formula (II):
F(x)=ax⁴+bx³cx²+dx+e, where (II)
a comes in the range between 0 and −0.05;
b comes in the range between 0 and −0.2;
c comes in the range between 0 and 0.4;
d comes in the range between 0 and 0.15;
e comes in the range between 0 and 12 mm, and preferably between 0 and 11.34, and
the outer line preferably runs asymmetrically with respect to the F(x) axis.

24. The dental prosthesis moulding block according to claim 18, characterised in that the cutting surface of the dentin zone, which cuts both the first dentin surface and the second dentin surface centrally and perpendicularly to the bottom surface of the dental prosthesis moulding block, forms the shape according to Formula (III):
F(x)=ax⁵+bx⁴+cx³+dx²+ex+f; where (III)
a comes in the range of smaller than equal to 0 and −0.05;
b comes in the range of smaller than equal to 0 and −0.2;
c comes in the range between 0 and 0.2;
d comes in the range between 0 and −0.8;
e comes in the range between 0 and 0.5;
f comes in the range between 0 and 10, preferably between 8 and 9.8, and preferably the outer line runs asymmetrically with respect to the F(x) axis.

25. The dental prosthesis moulding block according to claim 18, characterised in that the cutting surface of the dentin zone, which cuts both the first dentin surface and the second dentin surface centrally and parallel to the bottom surface of the dental prosthesis moulding block, forms the shape according to Formula (IV):
G(x)=fx⁴+gx²+h; where (IV)
f comes in the range between −0.001 and 1;
g comes in the range between −0.2 and 0.2;
h comes in the range between −0.06 and 6; and
preferably the outer line runs symmetrically with respect to the G(x) axis.

26. The dental prosthesis moulding block according to claim 18, characterised in that the cutting surface of the dentin zone, which cuts both the first dentin surface and the second dentin surface centrally and parallel to the bottom surface of the dental prosthesis moulding block, forms the shape according to Formula (V):
G(x)=fx⁴+gx³+hx²+ix+j; where (V)
f comes in the range between −0.001 and 0.05;
g comes in the range between −0.002 and 0.005;
h comes in the range between −0.2 and 0.2;
i comes in the range between −0.06 and 0.06;
j comes in the range between −4.5 and 5.5; and
preferably the outer line runs symmetrically with respect to the G(x) axis.

27. The dental prosthesis moulding block according to claim 18, characterised in that the dentin zone is placed on a dentin base surface, the dentin base surface preferably forming the entire base surface of the dental prosthesis moulding block.

28. The use of a dental prosthesis moulding block according to claim 18 in order to produce a dental prosthesis part of an anterior tooth and/or canine region.

29. A method for producing a dental prosthesis part, characterised by the following steps:
a) providing a dental prosthesis moulding block according to any of claim 18;
b) selecting at least one dentin surface;
c) producing a dental prosthesis part that can be disposed in the anterior tooth and/or canine region in optionally at least two different sizes and/or colours using a CAD/CAM method by means of removing material from the dental prosthesis moulding block.

30. The method according to claim 29, characterised in that the material is removed such that the colour of the resulting dental prosthesis part is determined by the selectable dentin surface and/or the layer thickness of the enamel region.

31. The method according to claim 29, characterised in that the colour of the resulting dental prosthesis part can be determined in advance using the layer thickness of the enamel region by means of CAD software.
